(19) United States
(12) Patent Application Publication
(10) Pub. No.: US 2019/0047163 A1
(43) Pub. Date: Feb. 14, 2019

(54) SANDWICH-STRUCTURED CUTTER AND A HAIR TRIMMER

(71) Applicant: Specialife Industries Limited, New Territories (HK)

(72) Inventor: Tung Yan LAU, New Territories (HK)

(21) Appl. No.: 16/055,439

(22) Filed: Aug. 6, 2018

(30) Foreign Application Priority Data
Aug. 14, 2017 (CN) 201710692966.X

(51) Int. Cl. B26B 19/38; B26B 19/12

(52) U.S. Cl. CPC B26B 19/3846; B26B 19/3893; B26B 19/12

(57) ABSTRACT

A sandwich-structured cutter and a hair trimmer, the cutter including two fixed blades, each of which has a row of teeth at the front end, and a movable blade, which is sandwiched between the two fixed blades, can reciprocate relative to the two fixed blades in the longitudinal direction, and is an integrated blade. The movable blade has a row of teeth at the front end, the front ends of the teeth of the movable blade do not protrude from the front ends of the teeth of the fixed blades, and each tooth of the movable blade has a quadrangular cross-section shape, which includes parallel first pair sides and second pair sides forming four acute angles with the first pair sides. The cutter and the hair trimmer can lower the probability that the user gets injured and the cutting efficiency is high.

### TECHNICAL FIELD

The present invention relates to the technical field of care supplies, and in particular relates to a sandwich-structured cutter and a hair trimmer using the cutter.

### BACKGROUND ART

Traditional hair scissors for personal care, for example, electric clippers and electrical shavers, generally consist of a cutter, a blade carrier and a handheld portion. The cutter generally comprises a fixed blade and a movable blade which overlap each other; a row of cutter teeth is provided at the front edge of the movable blade and the left and right sides of each cutter tooth are cutter edges; a row of cutter teeth is provided at the front edge of the fixed blade and each cutter tooth's inner surface contacting the movable blade and the side of the combing tooth form a sharp angle; the front edges of the movable blade and the fixed blade overlap each other, the movable blade is driven by the driving component in the blade carrier so that the movable blade moves horizontally relative to the fixed blade, and thus the hair in the clearance between combing teeth of the fixed blade is cut.

However, since the movable blade, especially the cutter tooth at the front edge of the movable blade is exposed or partially exposed to the user, the user is apt to get injured or it may cause a mental burden to the user.

### SUMMARY OF THE INVENTION

To overcome the defects and disadvantages of the prior art, the objective of the present invention is to provide a cutter with an unexposed movable blade and a higher cutting efficiency, and a hair trimmer using the cutter.

According to a solution of the present invention, a sandwich-structured cutter is provided and the cutter comprises:

two fixed blades, each of which has a row of teeth at the front end, and

a movable blade, which is sandwiched between the two fixed blades, can reciprocate relative to the two fixed blades in the longitudinal direction, and is an integrated blade,

wherein the movable blade has a row of teeth at the front end, the front ends of the teeth of the movable blade do not protrude from the front ends of the teeth of the fixed blades, and each tooth of the movable blade has a quadrangular cross-section shape, which comprises parallel first pair sides and second pair sides forming four acute angles with the first pair sides.

Preferably, each of second pair sides has at least one recess.

Alternatively, at least one recess comprises an angled recess.

Alternatively, at least one recess comprises an arced recess.

Alternatively, the two sides of the second pair sides are symmetrical.

Further, the cross-section shape of each tooth of the movable blade gradually becomes small from the root to the front end of the tooth and the length of the first pair sides remains unchanged.

Alternatively, at least one surface of the movable blade has a plurality of recessed portions, or the movable blade has a plurality of perforated holes.

Alternatively, an arced bulge is formed at the end, far away and/or near the movable blade, of each tooth of the two fixed blades.

Preferably, the end of each tooth of the two fixed blades has a fillet.

According to another solution of the present invention, a hair trimmer is provided and the hair trimmer comprises a driving rocker arm, a blade carrier, and the above-mentioned sandwich-structured cutter, wherein the two fixed blades are fixed on the blade carrier, and the driving rocker arm is pivotably fixed on the blade carrier and drives the movable blade to reciprocate.

The advantageous effects of the present invention are:

Through the design of the acute-angle cutting edge on the movable blade, the angle of the cutting edge is reduced and the cutting efficiency is improved. In addition, the design of the four acute-angle cutting edges enables the movable blade to cut not only the hair which is long enough to cross the two sides of the movable blade, but also the hair which is long enough to touch only one side of the movable blade. Moreover, hair of different lengths can be cut, no matter what direction the cutter is in.

By preventing the front end of the movable blade from protruding from the front end of the fixed blade, the probability that the user gets injured can be reduced and the fear of using this type of cutter can be overcome.

Through the integrated design of the movable blade in the present invention, instead of the combination of two or more separate components in the prior art, (i) any technical error in the depth of parallelism between the longitudinal plane of the movable blade and the longitudinal plane of each of the two fixed blades is reduced or eliminated, (ii) the procedural steps for manufacturing the blade are reduced and the molding cost is reduced so that the goal of reducing the manufacturing cost and manufacturing time is achieved.

By enabling each of the second pair sides to have at least one recess and providing the variants such as angled- and/or arced recesses, as much hair as possible can enter the recess, waiting for cutting, when the user uses the hair trimmer. In addition, manufacturers can conveniently design the hair trimmer according to their own molds.

By gradually reducing the cross-section shape of the teeth, the material for manufacturing teeth can be reduced, the overall weight of the cutter can be lightened, and as much hair as possible enters the teeth, waiting for cutting.

Through the design of the recessed portions on the surface of the movable blade, the friction area between the movable blade and the fixed blades is reduced and thus the sliding friction force between them is reduced. In addition, a material such as lubricating oil/grease can be put into these recessed portions to further reduce the sliding friction force, thus prolonging the service life of the movable blade.

Through the design of the arced bulge on at least one end of the two fixed blades and the design of the fillet at the end of a tooth, the user can be protected against any damage caused by blades during the operation of the cutter.

### BRIEF DESCRIPTION OF THE DRAWINGS

FIG. 1 shows the hair trimmer assembled with the sandwich-structured cutter in the present invention.

FIG. 2a shows the cross-section of the sandwich-structured cutter in the present invention.

FIG. 2b shows a tooth of the movable blade in the sandwich-structured cutter in the present invention.

FIG. 3 shows the movable blade of the cutter in a first implementation mode of the present invention.

FIG. 4 is an enlarged view of Part I of the movable blade shown in FIG. 3.

FIG. 5 shows the movable blade of the cutter in a second implementation mode of the present invention.

FIG. 6 is an enlarged view of Part II of the movable blade shown in FIG. 5.

FIG. 7 shows the two fixed blades of the cutter in a third implementation mode of the present invention.

FIG. 8 is a side view of Part III of the fixed blade shown in FIG. 7.

FIG. 9 is an enlarged view of Part III of the fixed blade shown in FIG. 7.

FIG. 10 shows the two fixed blades of the cutter in a fourth implementation mode of the present invention.

FIG. 11 is a side view of Part IV of the fixed blade F4 shown in FIG. 10.

FIG. 12 is an enlarged view of Part IV of the fixed blade F4 shown in FIG. 10.

FIG. 13 shows the two fixed blades of the cutter in a fourth implementation mode of the present invention.

FIG. 14 is a side view of Part V of the fixed blade shown in FIG. 13.

FIG. 15 is an enlarged view of Part V of the fixed blade shown in FIG. 13.

FIG. 16 is an exploded view of one implementation mode of the hair trimmer in the present invention.

FIG. 17 is a partially exploded view of the implementation mode of the hair trimmer shown in FIG. 16.

FIG. 18 is a partially exploded view of the implementation mode of the hair trimmer shown in FIG. 16.

FIG. 19 shows how the cutter in the present invention cuts hair.

### DETAILED DESCRIPTION OF THE INVENTION

According to the embodiments of the present invention, a sandwich-structured cutter is provided.

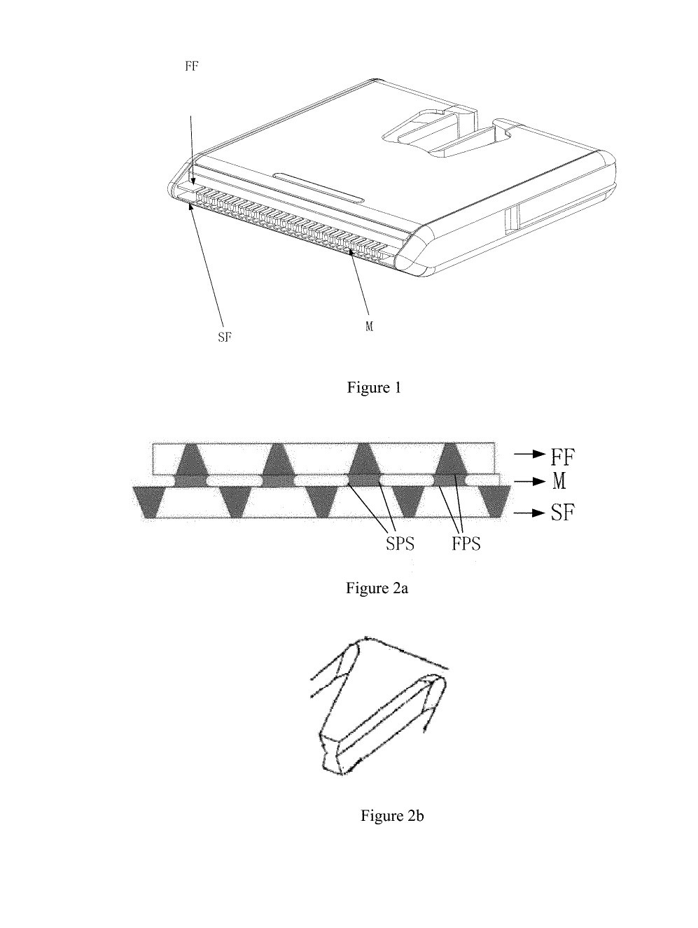

FIG. 1 shows the hair trimmer assembled with the sandwich-structured cutter in the present invention, and FIG. 2a shows the cross-section of the sandwich-structured cutter in the present invention. As shown in FIG. 1 and FIG. 2a, the cutter comprises two fixed blades and one movable blade.

Of the two fixed blades (first fixed blade and second fixed blade) FF and SF, each fixed blade has a row of teeth at the front end and the shape of the teeth of the fixed blades can be the same. After the two fixed blades are installed, the teeth of one fixed blade correspond to the teeth of the other fixed blade, that is to say, the clearances between teeth of one fixed blade correspond to the clearances between teeth of the other fixed blade. Or the teeth of the two fixed blade can be staggered, that is to say, the teeth of one fixed blade correspond to the clearances between the teeth of the other fixed blade.

The movable blade M is sandwiched between the two fixed blades and can reciprocate relative to the two fixed blades FF and SF in the longitudinal direction of the movable blade M, and the movable blade M is an integrated blade.

The movable blade M has a row of teeth at the front end, the front ends of the teeth of the movable blade M do not protrude from the front ends of the teeth of the fixed blades M, and each tooth of the movable blade M has a quadrangular cross-section shape, which comprises parallel first pair sides (FPS) and second pair sides (SPS) forming four acute angles with the first pair sides FPS.

In the embodiments of the present invention, each of the second pair sides SPS can have at least one recess. At least one recess of the second pair sides can include, for example, an angled recess. In one embodiment, as shown in FIG. 2b, the second pair sides of the quadrangular cross-section shape of the movable blade can comprise a blunt-angle recess. Or at least one recess of the second pair sides can include, for example, an arced recess. FIGS. 1 and 2 schematically show an arced recess which a second pair side SPS has. The shape of the second pair sides can include only an angled recess, or include only an arced recess, or include an angled recess and an arced recess, as long as the second pair sides SPS form four acute angles with the first pair sides FPS.

In the embodiments of the present invention, the shapes of the two sides of the second pair sides can be symmetrical. FIGS. 1 and 2a schematically show two symmetrical arced recesses which the second pair sides SPS have.

In some embodiments of the present invention, the cross-section shape of each tooth of the movable blade M can gradually become small from the root to the front end of the tooth and the length of the first pair sides remains unchanged.

In another embodiment of the present invention, one surface of the body portion of the movable blade can have a plurality of recessed portions, which can be used to place lubricating oil on. The recessed portions on the surface of the movable blade can be in the shape of a cylinder or truncated cone. Alternatively, the two surfaces of the body portion of the movable blade can both have a plurality of recessed portions, and the shapes of the recessed portions on the two surfaces can be the same or different, and can be symmetrical or asymmetrical. Alternatively, the body portion of the movable blade can have a plurality of perforated holes which pass through the movable blade in the thickness direction. According to the embodiments of the present invention, the design of the surface of the movable blade can reduce the friction area between the movable blade and the fixed blades, and then can reduce the sliding friction force, and in addition, a material such as lubricating oil/grease can be put into these recessed portions to further reduce said sliding friction force.

In some embodiments of the present inventions, an arced bulge is formed at the end, far away and/or near the movable blade, of each tooth of the two fixed blades, and the arced bulge can be integrated with the fixed blades or can be formed after the fixed blades are formed.

In some embodiments of the present invention, the two ends of each tooth of the two fixed blades in the tooth arrangement direction can have a fillet.

In some embodiments of the present invention, the teeth of the movable blade can be designed to be parallel. For example, they are all perpendicular to the front end of the body portion of the movable blade or form an angle of inclination. Alternatively, the teeth of movable blade can be designed to be non-parallel. For example, the bottoms of the two teeth in pair are close to or far away from each other, while the tops of the two teeth in pair are on the contrary far away or close to each other.

The following will describe a plurality of implementation modes of the cutter according to the embodiment of the present invention.

First Implementation Mode of the Cutter

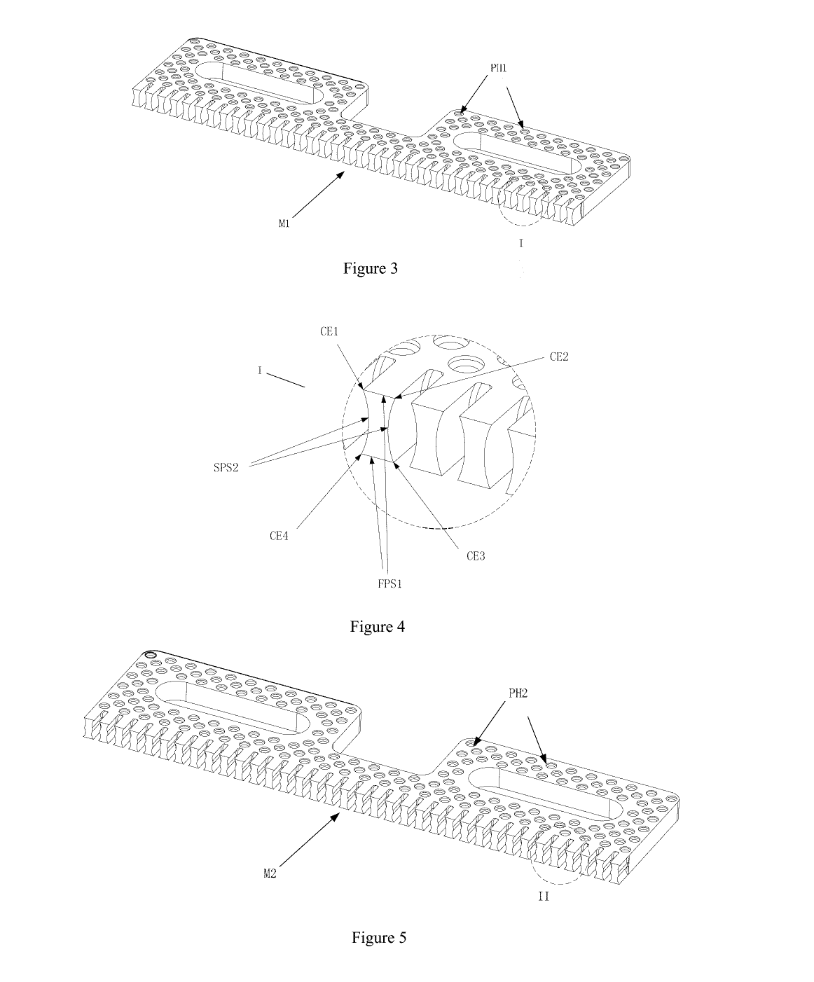

FIG. 3 shows the first implementation mode of the present invention and shows the movable blade M1 of the cutter in the first implementation mode of the present invention, and FIG. 4 is an enlarged view of Part I of the movable blade shown in FIG. 3.

The movable blade M1 of the cutter in the first implementation mode of the present invention is an integrated blade and has a row of teeth at the front end, and each tooth has a quadrangular cross-section shape, which comprises parallel first pair sides FPS1 and second pair sides SPS1 forming four acute angles with the first pair sides FPS1. The first pair sides FPS1 contact the two fixed blades and form four acute-angle cutting edges (CEs), namely, first cutting edge CE1, second cutting edge CE2, third cutting edge CE3, and fourth cutting edge CE4, with the two fixed blades on the cross-section. Wherein each of the second pair sides SPS2 has an arced recess and the two sides of the second pair sides SPS2 are symmetrical. In the present implementation mode, the movable blade has a plurality of perforated holes PH1, which can be used to place lubricating oil on.

Second Implementation Mode of the Cutter

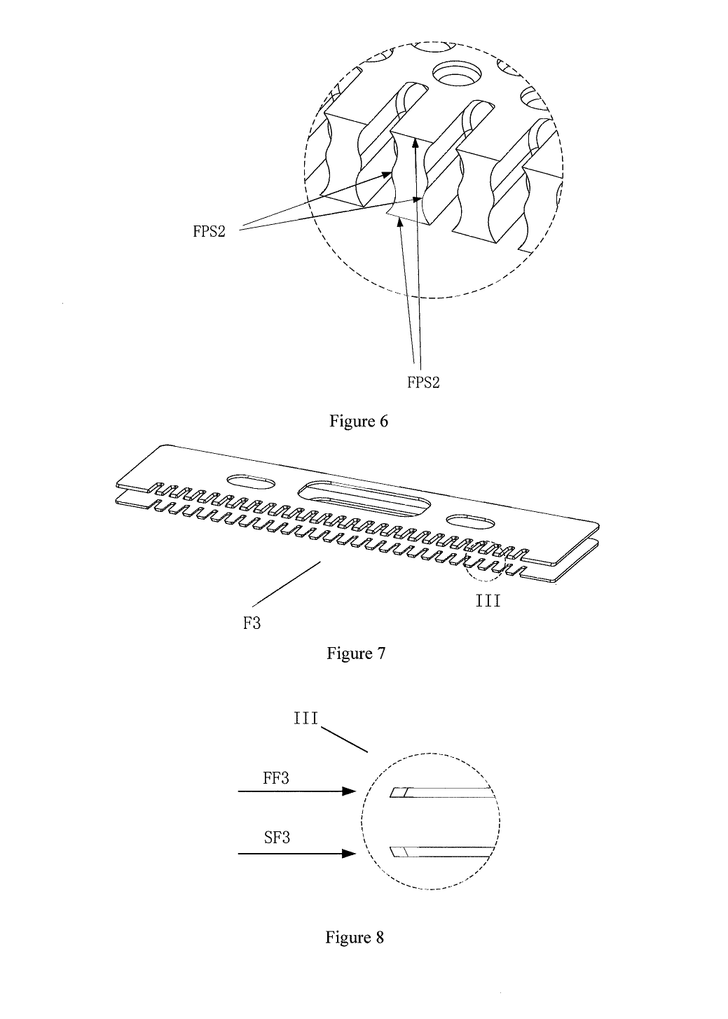

FIG. 5 shows the second implementation mode of the present invention and shows the movable blade M2 of the cutter in the second implementation mode of the present invention, and FIG. 6 is an enlarged view of Part II of the movable blade shown in FIG. 5.

The movable blade M2 of the cutter in the second implementation mode of the present invention is an integrated blade and has a row of teeth at the front end, and each tooth has a quadrangular cross-section shape, which comprises parallel first pair sides FPS2 and second pair sides SPS2 forming four acute angles with the first pair sides FPS2. The first pair sides FPS2 contact the two fixed blades and form four acute-angle cutting edges with the two fixed blades on the cross section. Each side of the second pair sides SPS2 has a plurality of arced recesses similar to waveforms. FIGS. 5 and 6 schematically show limited numbers of peaks and troughs of a plurality of arced recesses. In practice, the numbers and arrangement mode of peaks and troughs can be determined by the manufacturer. In addition, the two sides of the second pair sides SPS2 are symmetrical. In the present implementation mode, the movable blade has a plurality of perforated holes PH2, which can be used to place lubricating oil on.

Third Implementation Mode of the Cutter

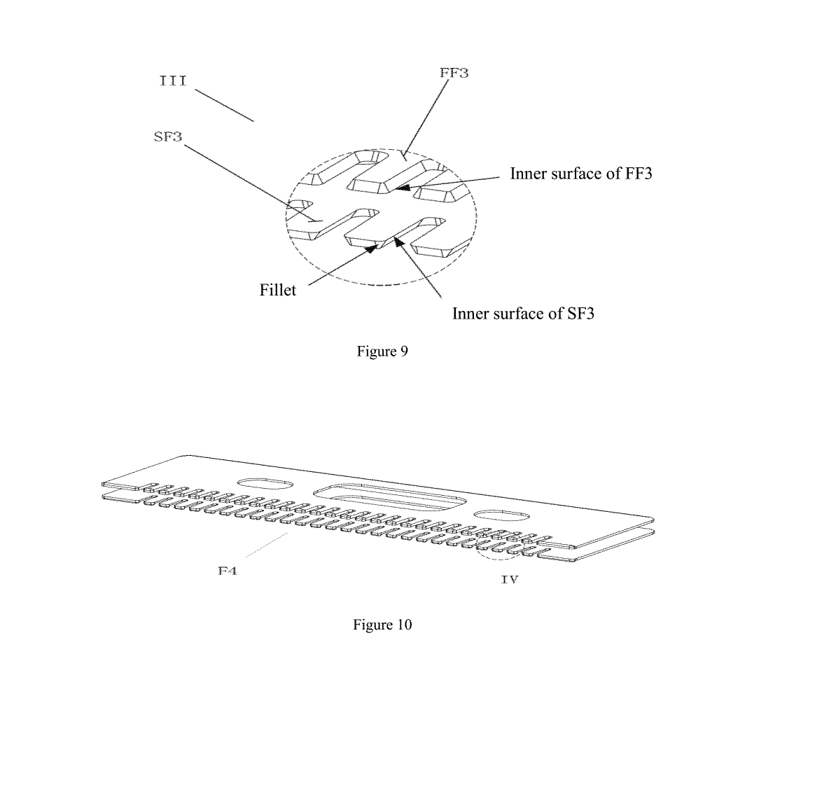

FIG. 7 shows the third implementation mode of the present invention and shows the two fixed blades F3 of the cutter in the third implementation mode of the present invention, FIG. 8 is a side view of part III of the fixed blades F3 shown in FIG. 7, and FIG. 9 is an enlarged view of part III of the fixed blades F3 shown in FIG. 7.

Each of the two fixed blades, namely, the first fixed blade FF3 and the second fixed blade SF3, of the cutter in the third implementation mode of the present invention has a row of teeth at the front end. Wherein, after the two fixed blades are assembled into a cutter, a clearance is reserved between them and the movable blade can be sandwiched in the clearance. The inner surface of the first fixed blade FF3 and the inner surface of the second fixed blade SF3 contact the movable blade to cut hair. Each tooth has a fillet on the two sides of the front end to prevent scratching the skin of the user. As shown in FIG. 9, the cross-sections of the teeth of the two fixed blades are isosceles trapezoids, that is to say, a sharp angle is formed between the tooth edges where the two fixed blades contact the movable blade so as to improve the cutting efficiency.

Fourth Implementation Mode of the Cutter

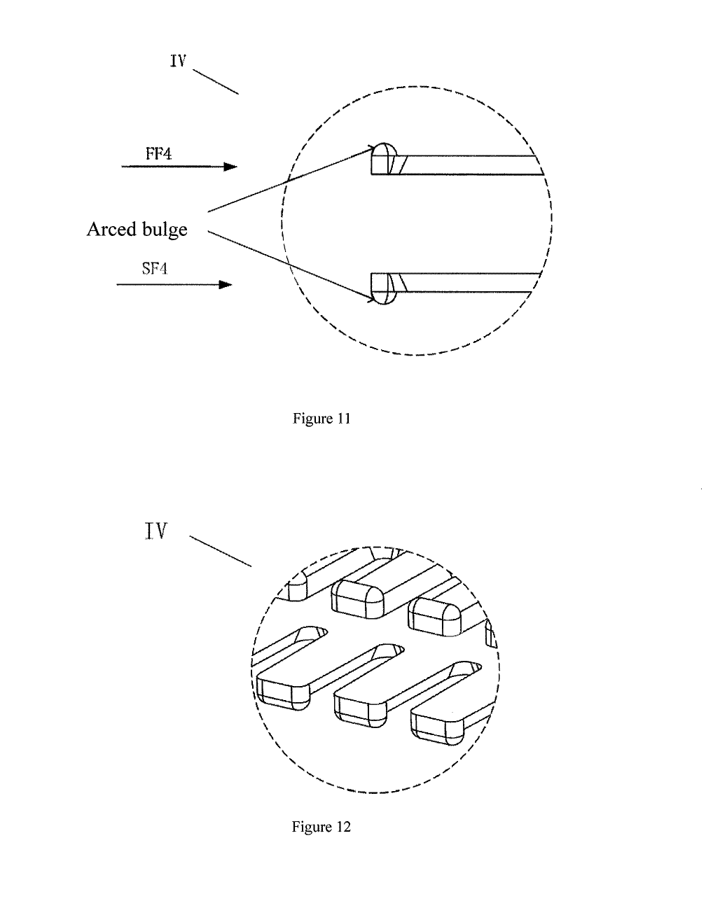

FIG. 10 shows the fourth implementation mode of the present invention and shows the two fixed blades F4 of the cutter in the fourth implementation mode of the present invention, FIG. 11 is a side view of part IV of the fixed blades F4 shown in FIG. 10, and FIG. 12 is an enlarged view of part IV of the fixed blades F4 shown in FIG. 10.

Each of the two fixed blades, namely, the first fixed blade FF4 and the second fixed blade SF4, of the cutter in the fourth implementation mode of the present invention has a row of teeth at the front end. Wherein, after the two fixed blades are assembled into a cutter, a clearance is reserved between them and the movable blade can be sandwiched in the clearance. The inner surface of the first fixed blade FF4 and the inner surface of the second fixed blade SF4 contact the movable blade to cut hair. Each tooth has a fillet on the two sides of the front end. An arced bulge is formed at the end, far away from the movable blade to be assembled, of each tooth of the two fixed blades to protect the user against any inj ury caused by the blades during the operation of the cutter. In addition, the connected portion between the arced bulge and the teeth has also undergone fillet treatment, and therefore it will not injure the user.

Fifth Implementation Mode of the Cutter

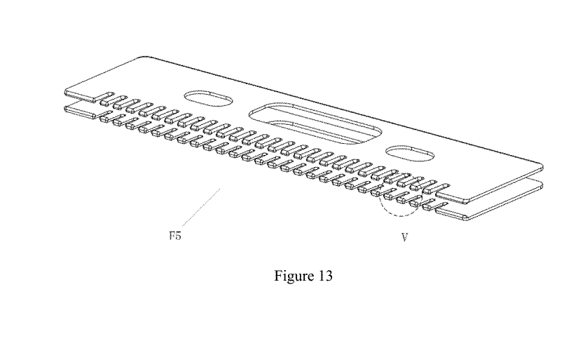

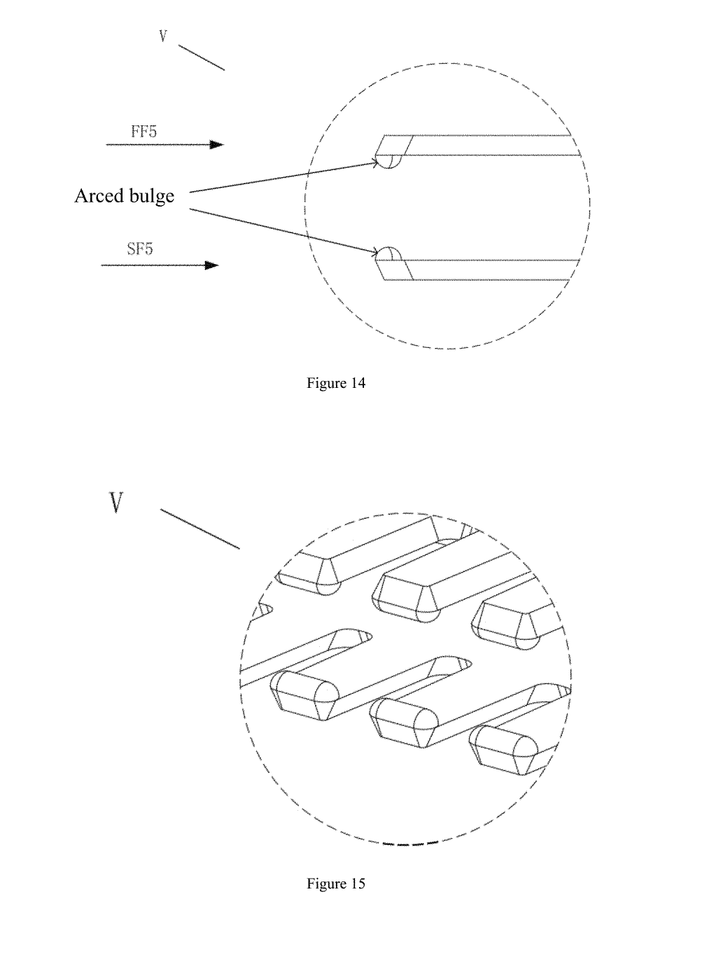

FIG. 13 shows the fifth implementation mode of the present invention and shows the two fixed blades F5 of the cutter in the fifth implementation mode of the present invention, FIG. 14 is a side view of part V of the fixed blades F5 shown in FIG. 13, and FIG. 15 is an enlarged view of part V of the fixed blades F5 shown in FIG. 13.

The cutter in the fifth embodiment mode of the present invention comprises two fixed blades, namely, a first fixed blade FF5 and a second fixed blade SF5. The difference of the fifth implementation mode from the fourth implementation mode is that an arced bulge is formed at the end, near the movable blade to be assembled, of each tooth of the two fixed blades and the bulge can also protect the user against any injury caused by the blades during the operation of the blades. In addition, the connected portion between the arced bulge and the teeth has also undergone fillet treatment, and therefore it will not injure the user.

According to another embodiment of the present invention, a hair trimmer is provided and the hair trimmer comprises a driving rocker arm, a blade carrier, and the above-mentioned sandwich-structured cutter, wherein the two fixed blades are fixed on the blade carrier, and the driving rocker arm is pivotably fixed on the blade carrier and drives the movable blade to reciprocate to realize cutting.

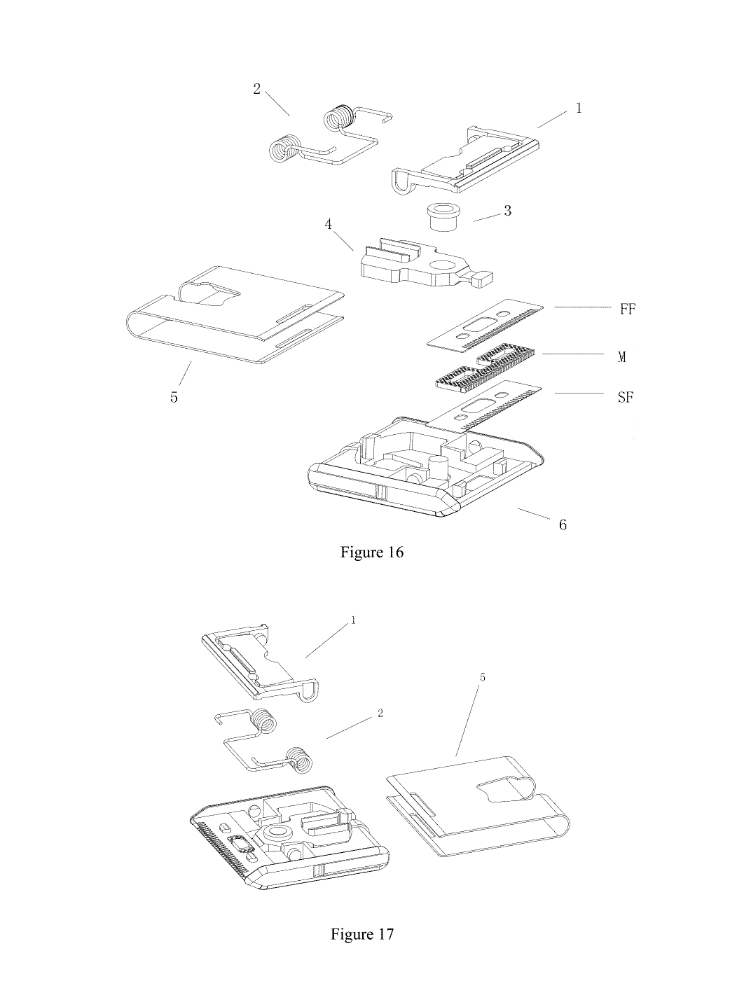

FIG. 16 is an exploded view of one implementation mode of the hair trimmer in the present invention. According to the present invention, the hair trimmer can comprise a pressure frame 1, a pressure spring 2, an axle sleeve 3, a rocker arm 4 (namely, driving rocker arm), a blade carrier cover 5, a blade carrier 6, and a sandwich-structured cutter consisting of two fixed blades FF and SF and a movable blade M.

FIG. 17 is a partially exploded view of the implementation mode of the hair trimmer shown in FIG. 16. In FIG. 17, the pressure frame 1, the pressure spring 2, and the blade carrier cover 5 are not assembled on the hair trimmer.

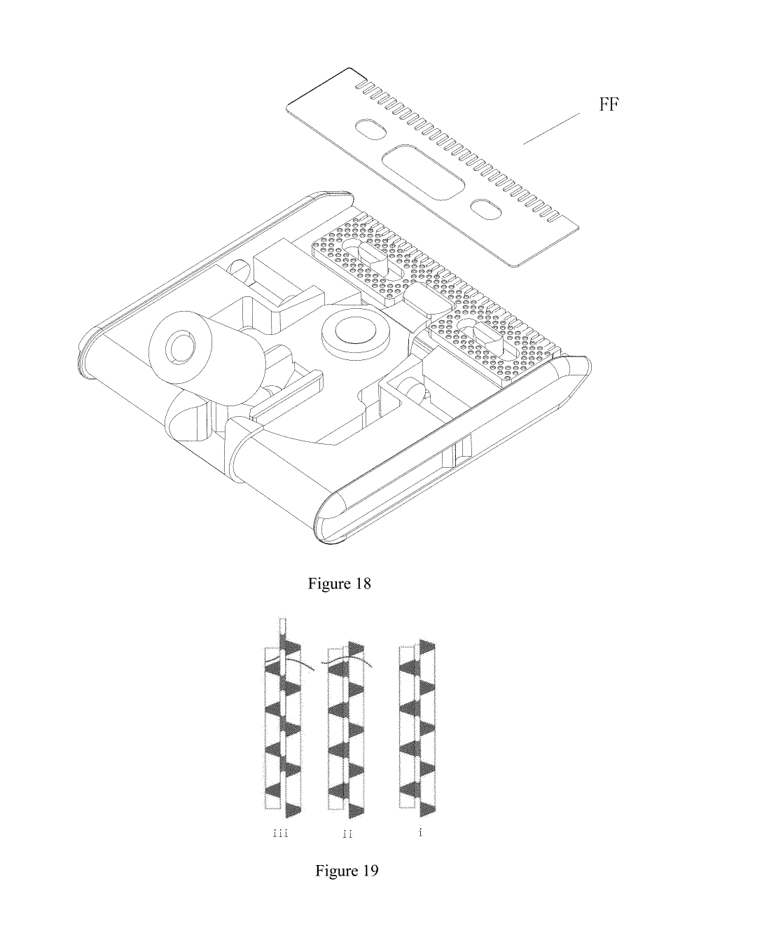

FIG. 18 is a partially exploded view of the implementation mode of the hair trimmer shown in FIG. 16. In FIG. 18, one fixed blade FF is not assembled on the hair trimmer.

FIG. 19 shows how the cutter in the present invention cuts hair. FIG. 19i shows the cross-section of the cutter and there is no hair in the cutter, FIG. 19ii shows a hair in the clearance between three blades, and FIG. 19iii shows that the movable blade can be driven by the driving rocker arm to move upward to cut the hair.

In the present invention, the above-mentioned implementation modes can be combined, without departing from the scope of the present invention.

1. A sandwich-structured cutter, comprising:
two fixed blades, each of which has a row of teeth at the front end, and
a movable blade, which is sandwiched between said two fixed blades, can reciprocate relative to said two fixed blades in the longitudinal direction, and is an integrated blade,
wherein said movable blade has a row of teeth at the front end, the front ends of the teeth of the movable blade do not protrude from the front ends of the teeth of said fixed blades, and each tooth of said movable blade has a quadrangular cross-section shape, which comprises parallel first pair sides and second pair sides forming four acute angles with said first pair sides.

2. The cutter according to claim 1, wherein each of said second pair sides has at least one recess.

3. The cutter according to claim 2, wherein said at least one recess comprises an angled recess.

4. The cutter according to claim 2, wherein said at least one recess comprises an arced recess.

5. The cutter according to claim 1, wherein the two sides of said second pair sides are symmetrical.

6. The cutter according to claim 1, wherein the cross-section shape of each tooth of said movable blade gradually becomes small from the root to the front end of the tooth and the length of said first pair sides remains unchanged.

7. The cutter according to claim 1, wherein at least one surface of said movable blade has a plurality of recessed portions, or said movable blade has a plurality of perforated holes.

8. The cutter according to claim 1, wherein an arced bulge is formed at the end, far away and/or near the movable blade, of each tooth of said two fixed blades.

9. The cutter according to claim 1, wherein the end of each tooth of said two fixed blades has a fillet.

10. A hair trimmer, comprising a driving rocker arm, a blade carrier, and the sandwich-structured cutter as claimed in claim 1, wherein said two fixed blades are fixed on said blade carrier, and said driving rocker arm is pivotably fixed on said blade carrier and drives said movable blade to reciprocate.
